(19) United States
(12) Patent Application Publication
(10) Pub. No.: US 2011/0269005 A1
(43) Pub. Date: Nov. 3, 2011

(54) BATTERY HOLDER

(75) Inventor: ZHENG-HENG SUN, Tu-Cheng (TW)

(73) Assignee: HON HAI PRECISION INDUSTRY CO., LTD., Tu-Cheng (TW)

(21) Appl. No.: 12/953,479

(22) Filed: Nov. 24, 2010

(30) Foreign Application Priority Data
Apr. 28, 2010 (CN) 201010158444.X

(51) Int. Cl. H01M 2/10

(52) U.S. Cl. 429/99

(57) ABSTRACT

A battery holder comprises an upper part and a lower part. The upper part comprises a first support, a second support, a first substrate, a surrounding sidewall extending from the periphery of the first substrate, and the surrounding sidewall and the first substrate define a first receiving room to receive a first battery. The lower part is provided under the upper part, which comprises a second substrate, a stopper rotatably connected to an end of the first support, and a curved wall extending from an end of the second support. The stopper, the second substrate, and the curved wall define a second receiving room for receiving a second battery.

### BACKGROUND

1. Technical Field

The present application is related to battery holders, especially to a battery holder for storing a spare battery.

2. Description of Related Art

In contemporary computer systems, mercury batteries are commonly used in CMOS chips on a motherboard. However, when a mercury battery is out of power and is not replaced with a new one immediately, data in the CMOS chips can be lost. Therefore, what is desired is a battery holder to eliminate the foregoing problem.

### BRIEF DESCRIPTION OF THE DRAWINGS

FIG. 1 is an exploded perspective view of the battery holder of one embodiment of the present application.

FIG. 2 and FIG. 3 are partial, enlarged perspective views of FIG. 1.

FIG. 4 is a partial, cutaway view of the battery holder of FIG. 1, showing a receiving room of the battery holder for storing a spare battery.

FIG. 5 is an assembled view of the battery holder of FIG. 1, showing the battery holder and two batteries installed therein, viewed from a different direction from FIG. 1.

### DETAILED DESCRIPTION

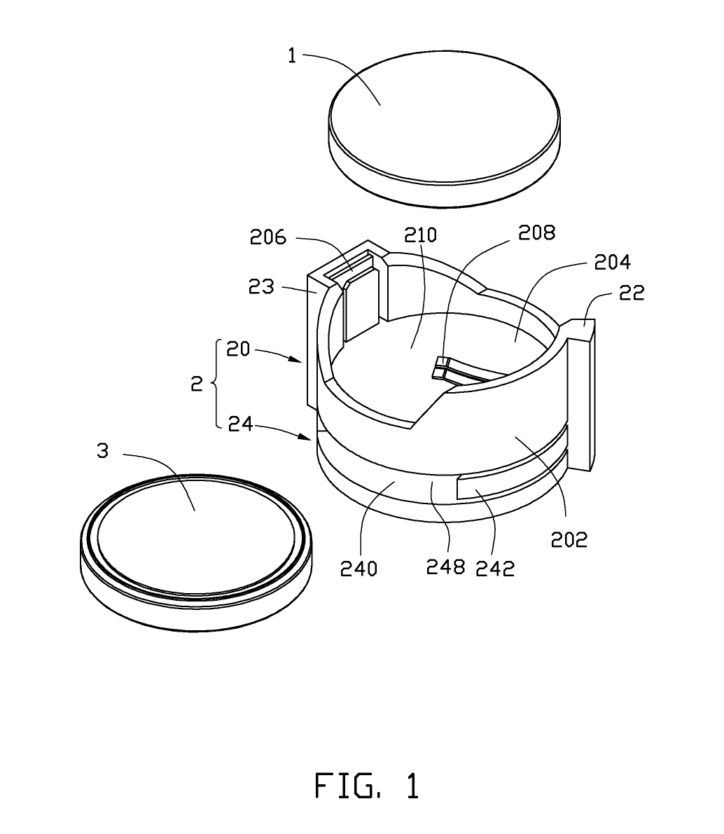

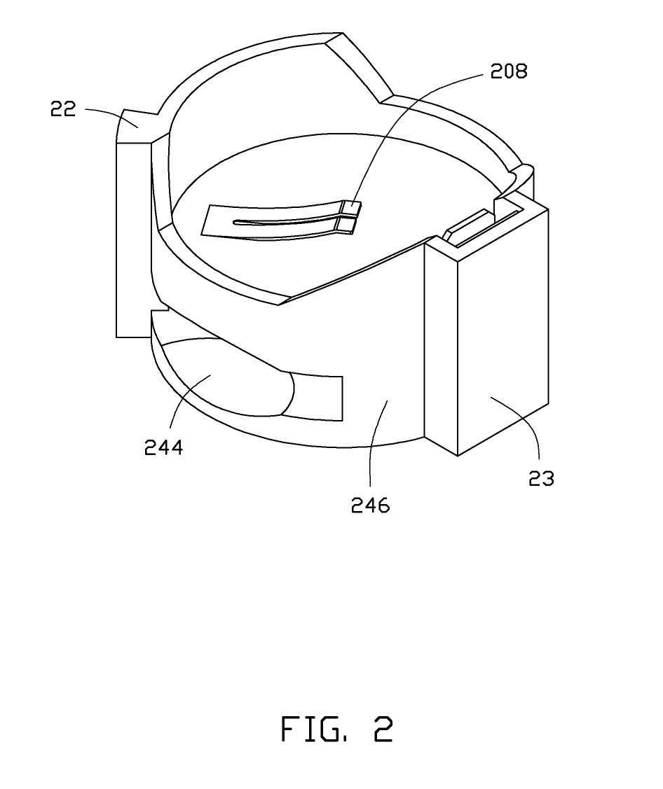

Referring to FIG. 1 and FIG. 2, a battery holder 2 of an embodiment of the present application comprises an upper part 20 and a lower part 24. The upper part 20 comprises a first support 22 and a second support 23. The battery holder 2 further comprises a first substrate 204, a surrounding sidewall 202 extending perpendicularly from the periphery of the first substrate 204, wherein the surrounding sidewall 202 and the first substrate 204 define a first receiving room 210 to receive a first battery 1.

The first battery 1 provides power to an electronic device through connection to a first contact 206 provided on an inner side of the surrounding sidewall 202, and a second contact 208 provided on the first substrate 204.

The lower part 24 of the battery holder 2, provided under the upper part 20, comprises a second substrate 240, a stopper 242 rotatably connected to one end of the first support 22, and a curved wall 246 extending from two sides of the second support 23. The stopper 242, the second substrate 240, and the curved wall 246 define a second receiving room 248 for receiving a second battery 3.

In this embodiment, the first and second batteries are mercury batteries. The stopper 242 is formed integrally with the first support 22, and can be deformed elastically to receive the second battery 3 inside the second room 248. The stopper 242 also can be embodied as pivotally connected to the first support 22 through a small hinge, or as rotatably connected to the first support 22 through a spring.

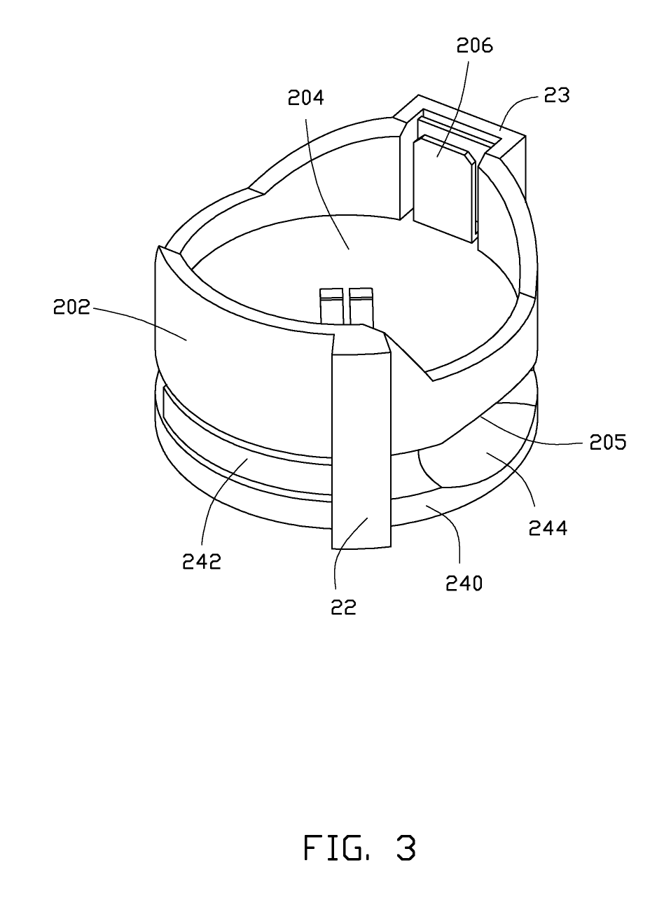

Referring to FIG. 3, a first recess 244 is formed on a surface of the second substrate 240 which faces the second receiving room 240, and a second recess 205 is formed on a surface of the first substrate 204 which faces the second receiving room 240. The first recess 244 and the second recess 205 all facilitate receiving of the second battery 3.

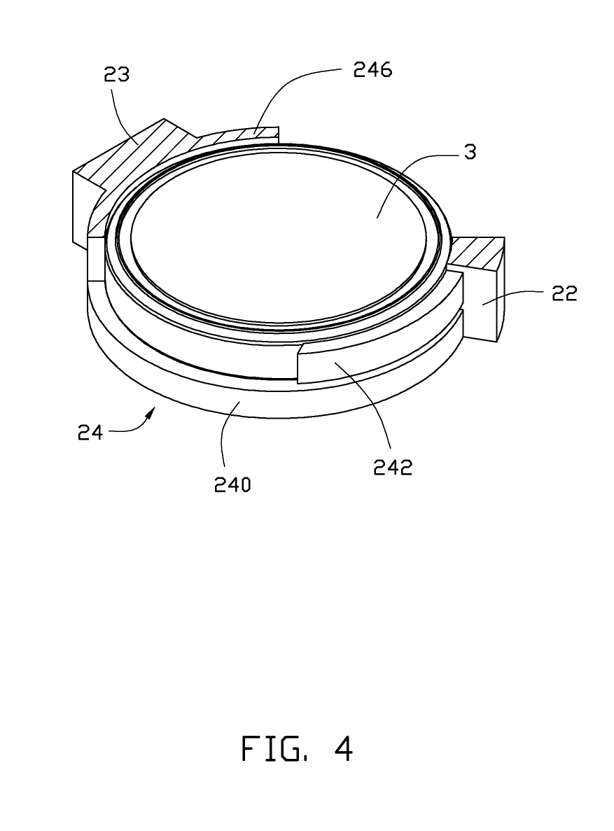

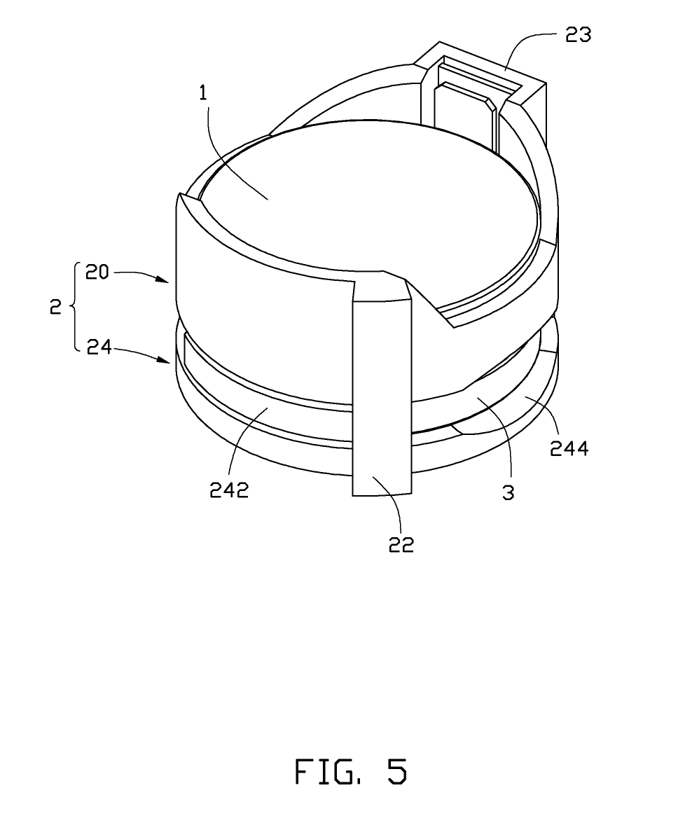

Referring to FIG. 4 and FIG. 5, the first battery 1 is received in the first receiving room 210 to provide power to an electronic device. The second battery 3 can be received in the second receiving room 240 from the space between the second support 23 and the stopper 242 by pushing the stopper 242 away. The first recess 244 of the second substrate 240 and the second recess 205 of the first substrate 210 facilitate seating of the second battery 3 in the second receiving room 248. After the second battery 3 is received in the second receiving room 240, the stopper 242 restores to maintain the second battery 3 in the second receiving room 248.

When the first battery 1 is exhausted, a user only needs to put his finger between the first recess 244 of the second substrate 240 and the second recess 205 of the first substrate 210, push the second battery 3 and into the first receiving room 210 to provide power to the electronics device through the first contact 206 and the second contact 208.

While having been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A battery holder, comprising:
an upper part, comprising a first support and a second support, wherein the upper part further comprises a first substrate, a surrounding sidewall extending perpendicularly from the periphery of the first substrate, and a first receiving room defined by the surrounding sidewall and the first substrate to receive a first battery;
a lower part provided under the upper part, comprising a second substrate, a stopper rotatably connected to an end of the first support, and a curved wall extending from an end of the second support, wherein a second receiving room is defined by the stopper, the second substrate, and the curved wall for receiving a second battery.

2. The battery holder as claimed in claim 1, wherein a first recess is formed on one side of the first substrate and faces the first receiving room, and a second recess is formed on one side of the second substrate and faces the second receiving room.

3. The battery holder as claimed in claim 1, wherein the stopper is rotatably connected to the first support and deforms elastically.

4. The battery holder as claimed in claim 1, wherein a first contact is provided on an inner side of the surrounding sidewall, and a second contact is provided on the first substrate, and the first and second contacts provide connection of the first battery to an electronic device.
